(19) United States
(12) Patent Application Publication
(10) Pub. No.: US 2005/0186416 A1
(43) Pub. Date: Aug. 25, 2005

(54) Hydrophilic articles

(75) Inventors: John M. Sebastian, Maplewood, MN (US); Stefan H. Gryska, Woodbury, MN (US); Thomas P. Klun, Lakeland, MN (US)

Correspondence Address: 3M INNOVATIVE PROPERTIES COMPANY, PO BOX 33427, ST. PAUL, MN, 55133-3427, US

(73) Assignee: 3M Innnovative Properties Company

(21) Appl. No.: 10/786,206

(22) Filed: Feb. 25, 2004

(51) Int. Cl. B32B 7/12

(52) U.S. Cl. 428/343

(57) ABSTRACT

A hydrophilic article is disclosed comprising a layer of a thermoplastic polymer, and an adhesive layer having a surfactant dispersed therein. The hydrophilic article is useful, for example, as ink-receptive substrates for aqueous inks, for fluid transport articles, wipes and absorbent articles.

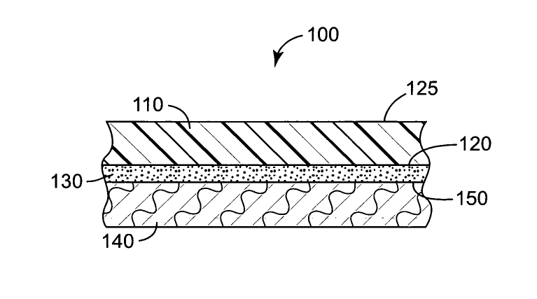

### FIELD OF THE INVENTION

The present invention relates to a hydrophilic article comprising a layer of a thermoplastic polymer, and an adhesive layer having a surfactant dispersed therein. The present invention also relates to a method of making such articles. The hydrophilic article is useful, for example, as ink-receptive substrates for aqueous inks, for fluid transport articles, wipes and absorbent articles.

### BACKGROUND OF THE INVENTION

Films from extruded thermoplastic polymers, such as polyolefins, are widely used in a variety of applications including, for example, as overhead transparencies, packaging materials, labels, ink-receptive substrates and backing material for adhesive tapes. In many applications, the films need to be provided with coatings or surface treatments to render the films hydrophilic. In order to provide good adhesion and coatability of such coatings, and particularly aqueous-based coatings, it is generally required to treat the film surface with a corona discharge before coating. While this treatment is generally effective, it makes the film surface rough. Moreover, the effect of a corona discharge treatment on the film surface may degrade with time. Accordingly, corona discharge treatment is generally only useful if it can be done in line with the coating of the film. However, in a number of applications that may not be practical.

Further, in many applications, these substrates need to be provided with printed information such as text and images, including color images. Often, this printed information is provided thereon by ink printing, in particular by inkjet printing. Unfortunately, untreated thermoplastic polymer substrates, when printed in this way, suffer from a number of disadvantages. For example, the appearance of the image may be poor as a result of bleeding of colors and/or coalescence of colors. Furthermore, some inks suffer from slow drying and some may only dry superficially without completely drying throughout within acceptable times. Though these problems are especially noticeable when the ink used is an aqueous based ink, they are not exclusively observed with aqueous based inks. Accordingly, there is a need for a solution that can provide these thermoplastic polymer substrates with improved printability properties.

It is further known in the art to modify the surface properties of a thermoplastic polymer by adding a compound during the extrusion of the thermoplastic polymer.

WO 92/18569 and WO 95/01396 describe fluorochemical additives for use in the extrusion of thermoplastic polymers to prepare films and fibers with repellency properties. It is specifically disclosed that films can be prepared with good anti-wetting properties. It is further taught that polypropylene films with the fluorochemical dispersed therein have good antistatic properties.

Furthermore, the addition of one or more surfactants to the melts of thermoplastic polymers to impart hydrophilicity to both the surface and the bulk of the fiber is also taught in the art. U.S. Pat. Nos. 4,857,251 and 4,920, 168 (Nohr et al.) describe a method of forming fibers by melt-extrusion of a surface segregatable thermoplastic composition that comprises thermoplastic polymer and siloxane-containing additive having certain moieties. After the fibers are formed, they are heated from 27° C. to 95° C. for a period of time sufficient to increase the amount of additive at the fiber surface. The resulting fibers exhibit increased surface hydrophilicity compared to fibers prepared from the thermoplastic alone.

U.S. Pat. No. 5,804,625 (Temperante et al.) discloses the addition to the polymer melt of a blend of one or more nonionic fluorochemical surfactants and one or more nonionic, non-fluorinated, polyoxyethylene group containing surfactants to impart durable hydrophilicity to the surface of an article extruded from the polymer. Particular articles that can be produced and provided with durable hydrophilicity at the surface include fibers, fabrics and films.

EP 0 516 271 discloses the use of a fluoroaliphatic group containing nonionic compound in the extrusion of polypropylene fibers to impart durable wettability properties to the fiber's surface. Particularly exemplified compounds are those that have a perfluorinated alkyl group linked to a poly(oxyalkylene) group terminated with a hydroxyl group or a lower alkyl ether.

### SUMMARY

Accordingly, there is a need for a thermoplastic polymer articles with a hydrophilic surface. As will be set forth in detail below, the present invention solves this problem by dispersing a surfactant in an adhesive layer bonded to the polymer layer of the article. The surfactant may be nonionic, anionic, or amphoteric surfactants or mixtures thereof. The polymer layer may be in the form of a nonporous film, a membrane or a fibrous layer, such as a woven or nonwoven fabric.

The present invention provides a hydrophilic article comprising a polymeric layer having a first hydrophilic surface and a second surface having an adhesive layer bonded thereto, said adhesive layer comprising sufficient surfactant dispersed therein which migrates to said first surface of said polymeric layer, rendering it hydrophilic. While a range of surfactant concentrations may be used in the practice of the invention, generally the adhesive layer will contain at least 3 wt. % surfactant, based on the total weight of the adhesive layer. Preferably the pressure sensitive adhesive layer comprises from at least 5 percent by weight up to and including 40 percent by weight of at least one surfactant, based on the total weight of the adhesive layer.

In another aspect, the present invention provides a method of making a hydrophilic article comprising contacting a pressure sensitive adhesive with a major surface of a first thermoplastic polymer layer, wherein the adhesive comprises from greater than 3 percent by weight up to and including 40 percent by weight of at least one surfactant based on the total weight of the adhesive.

It will be understood that in connection with the present invention the use of the term “dispersed therein” denotes merely the initial presence of the surfactant in the adhesive layer without limitation as to where the surfactant may subsequently migrate. Thus the surfactant may be initially uniformly dispersed in the bulk of the adhesive or may have migrated to the surface of the thermoplastic polymer layer.

As used herein, “hydrophilic” is used only to refer to the surface characteristics of the thermoplastic polymer layer, i.e., that it is wet by aqueous solutions, and does not express whether or not the layer absorbs aqueous solutions. Accordingly, a thermoplastic polymer layer may be referred to as hydrophilic whether or not the layer is impermeable or permeable to aqueous solutions. Surfaces on which drops of water or aqueous solutions exhibit a contact angle of less than 90° are commonly referred to as “hydrophilic”.

The present invention solves the problem of the art by providing a reservoir for surfactants in an adhesive layer adhered to thermoplastic polymer layer, in order that the surface(s) of the polymer layer is rendered hydrophilic via migration of such surfactants from the adhesive into the polymer layer.

One aspect of the present invention is a method for providing a hydrophilic article comprising a thermoplastic polymer layer and an adhesive layer, comprising the steps of: (a) dispersing into an adhesive layer at least one surfactant that provides a hydrophilic surface to the polymer layer; and (b) adhering the adhesive to a thermoplastic polymer layer such that the adhesive layer provides a surfactant reservoir for the polymer layer. A feature of the present invention is the ability to provide a reservoir of surfactant in an adhesive contacting the polymer layer to provide hydrophilicity over a period of time.

Unexpectedly, the method of the present invention not only provides a hydrophilic surface to a polymer layer adjoining the adhesive, but also, when the reservoir adhesive adjoins a membrane, other layers in a composite article. More specifically, if the reservoir adhesive adjoins a microporous membrane, the surfactants migrate through the membrane into additional layers in a multilayer article. Significantly, the surfactants in a reservoir may migrate across two different layers of two different materials to render a third layer hydrophilic. Thus, another advantage of the present invention is the ability to use multilayer films that might not contain any surfactants yet are provided a hydrophilic surface via surfactants that have migrated from an adhesive layer, through intermediate layers.

Another aspect of the present invention is a thermoplastic polymer layer that is rendered hydrophilic by an adjoining adhesive delivery system for surfactants that provides a hydrophilic surface to the adjoining thermoplastic polymer layer, and wherein the thermoplastic polymer layer itself is initially hydrophobic, prior to surfactant migration.

“Adhesive delivery system” means the use of adhesive to provide a reservoir for surfactants and to facilitate the migration of such surfactants from the adhesive layer into adjoining thermoplastic polymer layer(s). Use of this adhesive delivery system eliminates problems that occur in the two most common methods used for providing a hydrophilic surface to into thermoplastic polymers: extrusion and coating. Surfactants frequently cannot be directly compounded and extruded as a melt because of the low decomposition temperatures of the surfactants. In other cases, the surfactants may interfere with polymer nucleation, or may degrade the physical properties of the thermoplastic polymer during processing.

Coating methods to provide a hydrophilic surface also have some limitations. First of all, the extra step required in film preparation is expensive, time consuming and involves safety and environmental issues. Many of the solvents used for coating are flammable liquids or have exposure limits that require special production facilities. Furthermore the quantity of surfactant is limited by the solubility in the coating solvent and the thickness of the coating. Again, incorporation of surfactants into the adhesive can solve these problems. The “adhesive delivery system” of the present invention solves these problems.

The hydrophilic articles of the present invention are suitable for many purposes: as ink receptive substrates; in personal care products such as diapers, sanitary napkins, and incontinence devices; as fluid transport devices, whereby fluids are wicked or otherwise transported; as filter media, such as respirators: as surface wipes; and as antifogging films.

### BRIEF DESCRIPTION OF THE DRAWING

The drawing is an exemplary cross-sectional side view of a hydrophilic article according to the present invention.

### DETAILED DESCRIPTION

Referring now to the Figure, exemplary hydrophilic article 100 comprises thermoplastic polymer layer 110 having major surfaces 120 and 125. Pressure sensitive adhesive layer 130 contacts major surface 120, and optionally contacts major surface 150 of substrate 140. Pressure sensitive adhesive layer 130 comprises at least one pressure sensitive adhesive and at least 3 weight percent, on a total weight basis of the pressure sensitive adhesive layer, of at least one surfactant. In some embodiments of the present invention, substrate 140 may be, for example, a release liner.

Without wishing to be bound by theory, it is believed that surfactant in the adhesive layer gradually migrates from the pressure sensitive adhesive layer into the thermoplastic polymer layer. During use, exposure or storage, surfactant that has diffused to the thermoplastic polymer layer may be depleted. By providing a gradual release of surfactant from the adhesive reservoir, the thermoplastic polymer layer may be provided with a continuous supply of surfactant. It is believed that the migration of the surfactant from the adhesive layer through the thermoplastic polymer layer is a diffusion process, and therefore the T_{g} of the adhesive layer and thermoplastic polymer layers are preferably at or below 25° C., and is more preferably below about 0° C. Polymers in the glassy state are generally less permeable than those in the rubbery state, so polymers in the rubbery state are particularly useful. Heating the article may enhance the migration of the surfactant.

Examples of thermoplastic polymers for use in the thermoplastic polymer layer include polyesters, polyurethanes, polyamides and poly(alpha)olefins. Preferred thermoplastic polymers are poly(alpha)olefins. Poly(alpha)olefins can include the normally solid, homo-, co- and terpolymers of aliphatic mono-1-olefins (alpha olefins) as they are generally recognized in the art. Usually, the monomers employed in making such poly(alpha)olefins contain about 2 to 10 carbon atoms per molecule, though higher molecular weight monomers sometimes are used as comonomers. The invention is applicable also to blends of the polymers and copolymers prepared mechanically or in situ. Examples of useful monomers that can be employed to prepare the thermoplastic polymers include ethylene, propylene, butene, pentene, 4-methyl-pentene, hexene, and octene, alone, or in admixture, or in sequential polymerization systems. Examples of preferred thermoplastic polymers include polyethylene, polypropylene, propylene/ethylene copolymers, polybutylene and blends thereof. Processes for preparing the thermoplastic polymers are well known, and the invention is not limited to a polymer made with a particular process.

The thermoplastic polymer layer may in the form of a film, membrane or fibrous layer and may be oriented or unoriented. As used herein, the terms “fiber” and “fibrous” refer to particulate matter, generally thermoplastic resin, wherein the length to diameter ratio of the particulate matter is greater than or equal to about 10. Fiber diameters may range from about 0.5 micron up to at least 1,000 microns. Each fiber may have a variety of cross-sectional geometries, may be solid or hollow, and may be colored by, e.g., incorporating dye or pigment into the polymer melt prior to extrusion. For purposes of this invention, a “film” is distinguished from a “membrane” in that any porosity present in a film does not transcend the entire thickness of the film, whereas at least some porosity present in a membrane does transcend the entire thickness of the membrane to provide a fluid conduit between opposing surfaces.

Useful thermoplastic polymer layers include woven, knitted, and nonwoven fabrics. The fibrous thermoplastic polymer layer may have any thickness, but typically, the thickness is in a range of from at least 10, 25, or 1000 micrometers up to and including 0.5, 2.5, or even 5 millimeters or more.

The fibrous thermoplastic polymer layer may include non-woven webs manufactured by any of the commonly known processes for producing nonwoven webs. For example, the fibrous nonwoven web can be made by carded, air laid, spunlaced, spunbonding or melt-blowing techniques or combinations thereof. Spunbonded fibers are typically small diameter fibers that are formed by extruding molten thermoplastic polymer as filaments from a plurality of fine, usually circular capillaries of a spinneret with the diameter of the extruded fibers being rapidly reduced. Meltblown fibers are typically formed by extruding the molten thermoplastic material through a plurality of fine, usually circular, die capillaries as molten threads or filaments into a high velocity, usually heated gas (e.g. air) stream which attenuates the filaments of molten thermoplastic material to reduce their diameter. Thereafter, the meltblown fibers are carried by the high velocity gas stream and are deposited on a collecting surface to from a web of randomly disbursed meltblown fibers. Any of the non-woven webs may be made from a single type of fiber or two or more fibers that differ in the type of thermoplastic polymer and/or thickness.

Further details on the manufacturing method of non-woven webs of this invention may be found in Wente, Superfine Thermoplastic Fibers, 48 INDUS. ENG. CHEM. 1342(1956), or in Wente et al., Manufacture Of Superfine Organic Fibers, (Naval Research Laboratories Report No. 4364, 1954).

Where the polymer layer is a microporous membrane, the membranes have a structure that enables fluids to flow through them. The effective pore size is at least several times the mean free path of the flowing molecules, namely form several micrometers down to about 100 Angstroms. Such sheets are generally opaque, even when made of transparent material, because the surfaces and the internal structure scatter visible light.

There are several methods known in the art to prepare a microporous membranes. A preferred method for producing the microporous membranes of the present invention utilizes the phase separation phenomenon that utilizes either liquid-liquid or solid-liquid phase separation. The method for producing microporous structures using these techniques usually involves melt blending the polymer with a compatible liquid that is miscible with the polymer at the casting or extrusion temperature, forming a shaped article of the melt blend, and cooling the shaped article to a temperature at which the polymer phase separates from the compatible liquid. Microporosity can be imparted to the resultant structure by, for example, (i) orienting the structure in at least one direction; (ii) removing the compatible liquid and then orienting the structure in at least one direction; or (iii) orienting the structure in at least one direction and then removing the compatible liquid. The cooling step for films is usually accomplished by contacting the film with a chill roll. This results in a thin skin being formed on the side of the membranes that contacts the chill roll, which results in a decrease in the fluid flow through the film.

Such methods are described, for example, in U.S. Pat. No. 4,247,498 (Castro), U.S. Pat. No. 4,539,256 (Shipman), U.S. Pat. No. 4,726,989 (Mrozinski) and U.S. Pat. No. 4,867,881 (Kinzer). Particulate-filled microporous membranes such as those described in, for example, U.S. Pat. No. 4,777,073 (Sheth), U.S. Pat. No. 4,861,644 (Young et al.), and U.S. Pat. No. 5,176,953 (Jacoby et al.), as well as JP 61-264031 (Mitsubishi Kasei KK), can also be utilized. Microporosity can be imparted to such particulate-filled films by, for example, orienting the film in at least one direction.

The thermoplastic polymer layer, whether film, membrane or fibrous, may comprise a pattern of elevated areas or relatively thick portions, separated by valleys, or relatively thin portions. The elevated areas take the form of ridges, mounds, peaks, cylinders, grooves or other embossments which may be uniform or varied in shape and dimensions and are generally disposed in a regular arrangement or pattern. “Pattern” does not necessarily refer to a regular repeating array, but may mean a random array of features having the same or different sizes. Patterns suitable for the practice of this invention include four-sided square pyramids, truncated four-sided square pyramids, cones, straight lines, wavy lines, square or rectangular blocks, hemispheres, grooves and the like and are imparted to at least a portion of the thermoplastic polymer layer. An individual feature of the pattern is referred to as an embossment. The number and spacing of embossments, as well as the nature of the individual embossment, such as its depth, degree of sharp reflecting edges, and shape can be varied as well. The terms “pattern” and “embossment” are used without reference to the process of application.

A plurality of embossments may be formed on the thermoplastic polymer layer. There are typically about 5 to 20 embossments per lineal centimeter. The embossments can be of any suitable depth, as long as the mechanical properties of the films are sufficient for the desired end use after the embossments have been formed. The depth of an embossment typically ranges from 10 to about 90 percent of the thickness of the oriented thermoplastic film. Preferably, the depth of an embossment typically ranges from 25 to 75 percent of the thickness of the thermoplastic polymer.

Embossing refers to a process in which a pattern is impressed into the surface of an article. Embossing is typically accomplished by means of a male pattern formed on a hard material such as a metal layer on an embossing roll. Those skilled in the art recognize that embossing can be done by several methods, including the use of a continuous tooled belt or sleeve. Preferred metal layers include those comprising nickel, copper, steel, and stainless steel. Patterns are typically acid etched or machined into the metal layer and can have a wide variety of sizes and shapes. Any pattern that can be scribed into a metal surface can be used in the practice of this invention. One useful embossing method is described in Assignee's U.S. Pat. No. 6,514,597, (Strobel et al.), incorporated herein by reference.

Embossing can be carried out by any means known in the art. The preferred method of embossing is to move the softened thermoplastic polymer layer (prior to coating with the adhesive layer) through a nip having an embossing surface. “Nip” refers to two rolls in proximity that apply pressure on a film when the film passes between them. The embossing surface contacts the film with sufficient force to create embossments in the softened surface of the thermoplastic polymer layer. The embossed surface is then cooled by any of a number of methods to reduce the temperature of the softened surface to below its softening temperature before the article has experienced a significant change in bulk properties resulting from prior orientation. Such methods include moving the film over one or more chilled rollers, delivering it to a water bath, or cooling by air or other gases, such as by use of an air knife.

In particular, the present invention provides a liquid transport article in which the thermoplastic polymer layer may comprise a microstructure-bearing surface with a plurality of channels that facilitate the directional flow of a liquid disposed thereon. The liquid control film may be incorporated to transport a liquid to a remote site, to collect a liquid on the film itself, or to disperse the liquid over an increased surface area to promote more rapid evaporation.

Such liquid transport films may be incorporated into an absorbent article comprising a liquid permeable topsheet, a backsheet, and an absorbent core disposed between the topsheet and the backsheet, wherein said article comprises at least on a liquid management member which comprises a sheet having at least one microstructure-bearing hydrophilic surface with a plurality of channels therein that promotes direction spreading of liquids, said hydrophic surface and said absorbent core being in contact said hydrophilic surface disposed on the interior surface of said backsheet.

Details regarding the size, shape and dimensions of channels may be found in U.S. Pat. No. 6,531,205 (Johnston et al.) and U.S. Pat. No. 6,080,243 (Insley et al), incorporated herein by reference. The making of structured surfaces, and in particular microstructured surfaces, on a polymeric layer such as a polymeric film are disclosed in U.S. Pat. Nos. 5,069,403 and 5,133,516, both to Marentic et al. Structured layers may also be continuously microreplicated using the principles or steps described in U.S. Pat. No. 5,691,846 to Benson, Jr. et al. Other patents that describe microstructured surfaces include U.S. Pat. No. 5,514,120 to Johnston et al., U.S. Pat. No. 5,158,557 to Noreen et al., U.S. Pat. No. 5,175,030 to Lu et al., and U.S. Pat. No. 4,668,558 to Barber, each incorporated herein by reference.

Useful classes of surfactants include nonionic, anionic, and amphoteric surfactants.

One useful class of hydrocarbon nonionic surfactants include the condensation products of a higher aliphatic alcohol, such as a fatty alcohol, containing about 8 to about 20 carbon atoms, in a straight or branched chain configuration, condensed with about 3 to about 100 moles, preferably about 5 to about 40 moles, most preferably about 5 to about 20 moles of ethylene oxide. Examples of such nonionic ethoxylated fatty alcohol surfactants are the Tergitol™ 15-S series from Union Carbide and Brij™ surfactants from ICI. Tergitol™ 15-S Surfactants include C₁₁-C₁₅ secondary alcohol polyethyleneglycol ethers. Brij™97 surfactant is Polyoxyethylene(10) oleyl ether; Brij™58 surfactant is polyoxyethylene(20) cetyl ether; and Brij™ 76 surfactant is polyoxyethylene(10) stearyl ether.

Another useful class of hydrocarbon nonionic surfactants include the polyethylene oxide condensates of one mole of alkyl phenol containing from about 6 to 12 carbon atoms in a straight or branched chain configuration, with about 3 to about 100 moles, preferably about 5 to about 40 moles, most preferably about 5 to about 20 moles of ethylene oxide to achieve the above defined HLB. Examples of nonreactive nonionic surfactants are the Igepal™ CO and CA series from Rhone-Poulenc. Igepal™CO surfactants include nonylphenoxy poly(ethyleneoxy)ethanols. Igepal™ CA surfactants include octylphenoxy poly(ethyleneoxy)ethanols.

Another useful class of hydrocarbon nonionic surfactants include block copolymers of ethylene oxide and propylene oxide or butylene oxide with HLB values of about 6 to about 19, preferably about 9 to about 18, and most preferably about 10 to about 16. Examples of such nonionic block copolymer surfactants are the Pluronic™ and Tetronic™series of surfactants from BASF. Pluronic™ surfactants include ethylene oxide-propylene oxide block copolymers. Tetronic™ surfactants include ethylene oxide-propylene oxide block copolymers.

Still other useful hydrocarbon nonionic surfactants include sorbitan fatty acid esters, polyoxyethylene sorbitan fatty acid esters and polyoxyethylene stearates having HLBs of about 6 to about 19, preferably about 9 to about 18, and most preferably about 10 to about 16. Examples of such fatty acid ester nonionic surfactants are the Span™, Tween™, and Myj™ surfactants from ICI. Span™ surfactants include C₁₂-C₁₈ sorbitan monoesters. Tween™ surfactants include poly(ethylene oxide) C₁₂-C₁₈ sorbitan monoesters. Myj™ surfactants include poly(ethylene oxide) stearates.

Particularly suitable hydrocarbon nonionic surfactants include polyoxyethylene alkyl ethers, polyoxyethylene alkyl-phenyl ethers, polyoxyethylene acyl esters, sorbitan fatty acid esters, polyoxyethylene alkylamines, polyoxyethylene alkylamides, polyoxyethylene lauryl ether, polyoxyethylene cetyl ether, polyoxyethylene stearyl ether, polyoxyethylene oleyl ether, polyoxyethylene octylphenyl ether, polyoxyethylene nonylphenyl ether, polyethylene glycol laurate, polyethylene glycol stearate, polyethylene glycol distearate, polyethylene glycol oleate, oxyethylene-oxypropylene block copolymer, sorbitan laurate, sorbitan stearate, sorbitan distearate, sorbitan oleate, sorbitan sesquioleate, sorbitan trioleate, polyoxyethylene sorbitan laurate, polyoxyethylene sorbitan stearate, polyoxyethylene sorbitan oleate, polyoxyethylene laurylamine, polyoxyethylene laurylamide, laurylamine acetate, hard beef tallow propylenediamine dioleate, ethoxylated tetramethyldecynediol, fluoroaliphatic polymeric ester, polyether-polysiloxane copolymer, and the like.

Preferably, the hydrocarbon surfactant corresponds to the following formula:
Rₕ¹—Y¹—W—Y²—Rₕ², (I) wherein:
W represents a polyoxyalkylene group, preferably a polyoxyethylene group; Y¹ and Y² independently represent an oxygen or sulfur atom or a group of the formula —CO—, —COO—, —NH—, —CONH—, or —N(R)—, where R is an alkyl group or an aryl group;
Rₕ¹ represents an alkyl or an aryl group, or a combination thereof, that may be substituted or unsubstituted and that contains from 2 to about 20 carbon atoms whose skeletal chain may be straight-chained, branched, or, if sufficiently large, cyclic, or any combination thereof, the skeletal chain can also optionally include one or more catenary heteroatoms (such as oxygen, hexavalent sulfur, and trivalent nitrogen atoms) bonded to the carbon atoms of the skeletal chain, and
Rₕ² represents a hydrogen atom or is an alkyl or an aryl group, or a combination thereof, that may be substituted or unsubstituted and that contains from 2 to about 20 carbon atoms whose skeletal chain may be straight-chained, branched, or, if sufficiently large, cyclic, or any combination thereof, the skeletal chain can also optionally include one or more catenary heteroatoms such as oxygen, hexavalent sulfur, and trivalent nitrogen atoms bonded to the carbon atoms of the skeletal chain.

One or both of the depicted Rₕ¹ and Rₕ² may contain a polydialkylsiloxane group of the formula: 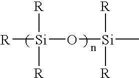
where all the depicted R groups are independently selected as alkyl or aryl groups having from 1 to about 10 carbon atoms that may be substituted or unsubstituted, straight-chained or branched, cyclic or acyclic, and may contain one or more catenary heteroatoms;

The variable W in the hydrocarbon surfactants according to the above formula I is a polyoxyalkylene group (OR¹)s, where R¹ is an alkylene group having from 2 to about 4 carbon atoms, such as —CH₂CH₂—, —CH₂CH₂CH₂—, —CH(CH₃)CH₂—, and —CH(CH₃)CH(CH₃)—, and s is a number such that the weight percent of oxyalkylene units in the hydrocarbon surfactant is between 20 and 80 percent and more preferably between 40 and 70 weight percent. The oxyalkylene units in the poly(oxyalkylene) group can be the same, such as in poly(oxypropylene) or poly(oxyethylene), or present as a mixture, such as in a hetero straight or branched chain of randomly distributed oxyethylene and oxypropylene units i.e., poly(oxyethylene-co-oxypropylene), or as in a straight or branched chain blocks of oxypropylene units.

Representative hydrocarbon surfactants according to Formula I above include ethoxylated alkylphenols (such as the TRITON™ TX, IGEPAL™ CA and IGEPAL™ CO series, commercially available from Union Carbide Corp. and Rhone-Poulenc Corp. respectively), ethoxylated dialkylphenols (such as the IGEPAL™ DM series, also commercially available from Rhone-Poulenc Corp.), ethoxylated fatty alcohols (such as the TERGITOL™ series, commercially available from Union Carbide Corp.) and polyoxyethylene fatty acid mono-esters and diesters (such as the MAPEG™ MO and MAPEG™ DO series, commercially available from PPG Industries, Inc.).

Another class of non-fluorinated, nonionic polyoxyethylene-containing surfactants in accordance with the invention may be described by the following formula: 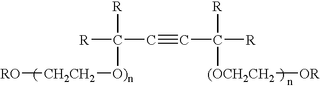
wherein:
each n is independently a number between 2 and about 20 and are chosen such that the weight percent of polyoxyethylene in the surfactant is between 20 and 80 percent, preferably between 30 and 60 percent; and
each R is selected independently from one another as an alkyl or an aryl group that may be substituted or unsubstituted and that contain from 2 to about 20 carbon atoms whose skeletal chain may be straight-chained, branched, or, if sufficiently large, cyclic, or any combination thereof; such skeletal chain can also optionally include one or more catenary heteroatoms such as oxygen, hexavalent sulfur, and trivalent nitrogen atoms bonded to the carbon atoms of the skeletal chain.

Another class of useful non-fluorinated, nonionic polyoxyethylene-containing surfactants useful in the practice of the invention include those organosiloxane compounds that may be represented generally by the following formula: 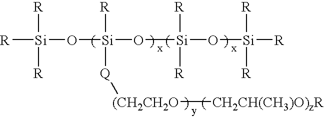
wherein:
n, x, y, and z denote the number of repeating units in the depicted surfactant and are chosen such that the weight percent of polyethylene oxide in the surfactant is between 20 and 80 percent, preferably between 40 and 70 percent, and most preferably between 40 and 60 percent; It will be understood that the recurring siloxane units in the depicted formula may be randomly situated in the surfactant molecule;
Q is a multivalent, generally divalent, linking group, or is a covalent bond, that provides a means to link the silicon atom to the depicted oxyalkylene group; Q can comprise a heteroatom-containing group, e.g., a group containing —O—, —CO—, —CₙH₂ₙO—, or —OCₙH₂ₙO— where n is a number from 1 to 6; and
each R is selected independently from one another as an alkyl, alkoxy, aryl or aryloxy group that may be substituted or unsubstituted and that contain from 1 to about 20 carbon atoms whose skeletal chain may be straight-chained, branched, or, if sufficiently large, cyclic, or any combination thereof, the skeletal chain can also optionally include one or more catenary heteroatoms such as oxygen, hexavalent sulfur, and trivalent nitrogen atoms bonded to the carbon atoms of the skeletal chain. Useful silicone surfactants of the type depicted by the formula include ethoxylated polydimethylsiloxanes, such as Silwet™ L-77, commercially available from Union Carbide Corp.

Useful fluorochemical surfactants include fluoroaliphatic group-containing nonionic compounds that contain one or more blocks of water-solubilizing polyoxyalkylene groups in their structures. A class of such surfactants is described in U.S. Pat. No. 5,300,357 (Gardiner), whose descriptions are incorporated herein by reference. Generally, the fluorochemical surfactants useful in the invention include those represented below by Formula II.
(R_{f}-Q)ₙ-Z (II)
wherein:
R_{f} is a fluoroaliphatic group having at least 3, preferably at least 4, most preferably 4 to 7 fully-fluorinated carbon atoms that may be straight-chained, branched, or, if sufficiently large, cyclic, or any combination thereof. The skeletal chain in the fluoroaliphatic radical can include one or more catenary heteroatoms, such as oxygen, hexavalent sulfur, and trivalent nitrogen atoms bonded only to carbon atoms of the skeletal chain. Fully fluorinated fluoroaliphatic groups are preferred, but hydrogen or chlorine atoms may be present as substituents provided that not more than one atom of either if present for every two carbon atoms. While R_{f} can contain a large number of carbon atoms, compounds where R_{f} is not more than 20 carbon atoms will be adequate and preferred since larger radicals usually represent a less efficient utilization of the fluorine than is possible with shorter chains. Fluoroaliphatic radicals containing from about 4 to about 7 carbon atoms are most preferred. Generally, R_{f} will contain between about 40 and about 78 weight percent fluorine. The terminal portion of the R_{f} group preferably contains at least three fully fluorinated carbon atoms, e.g., C₃F₇—, and particularly preferred compounds are those in which the R_{f} group is fully or substantially completely fluorinated, as in the case where R_{f} is a perfluoroalkyl, e.g., CF₃(CF₂)ₙ—. Suitable R_{f} groups include, for example, C₄F₇—, C₆F₁₃CH₂CH₂—, and C₁₀F₂₁CH₂CH₂—.
Q in Formula II above is a multivalent, generally divalent, linking group, or is a covalent bond, that provides a means to link R_{f} with the depicted group Z, which is a nonionic, hydrophilic group; Q can comprise a heteroatom-containing group, e.g., a group such as —S—, —O—, —CO—, —SO₂—, —N(R)—, (where R is a hydrogen or a C₁ to C₆ substituted or unsubstituted alkyl group that may comprise a catenary heteroatom such as O, N, S), —CₙH₂ₙ— (n=1 to 6); Q can comprise a combination of such groups such as would give, for example, —CON(R)CₙH₂ₙ—, —SO₂N(R)CₙH₂ₙ—, —SO₃C₆H₄N(R)CₙH₂ₙ—, —SO₂N(R)CₙH₂ₙO[CH₂CH(CH₂Cl)O]_{g}CH₂CH(CH₂Cl)— (n=1 to 6; g=1 to 10), —SO₂N(CH₃)C₂H₄₀CH₂CH(OH)CH₂—, —SO₂N(C₂H₅)C₂H₄₀CH₂CH(OH)CH₂—, —SO₂N(H)CH₂CH(OH)CH₂NHC(CH₃)CH₂—, —(CH₂)₂S(CH₂)₂—, and —(CH₂)₄CH(CH₃)—;
Z in Formula II above is a nonionic, hydrophilic group comprising a poly(oxyalkylene) group, (OR′)ₓ, where R′ is an alkylene group having from 2 to about 4 carbon atoms, such as —CH₂ CH₂—, —CH₂CH₂CH₂—, —CH(CH₃)CH₂—, and —CH(CH₃)CH(CH₃)—, and x is a number between about 4 and about 25; Z preferably contains a poly(oxyethylene) group. The oxyalkylene units in said poly(oxyalkylene) being the same, such as in poly(oxypropylene), or present as a mixture, such as in a heteric straight or branched chain of randomly distributed oxyethylene and oxypropylene units i.e., poly(oxyethylene-co-oxypropylene), or as in a straight or branched chain blocks of oxypropylene units. The poly(oxyalkylene) chain can be interrupted by or include one or more catenary linkages such as where Z includes a group of the formula —O—CH₂—CH(O—)—CH₂—O—, providing such linkages do not substantially alter the water-solubilizing character of the poly(oxyalkylene) chain. The Z group may be terminated with a hydroxyl, alkyl ether (such as C₁ to C₂₀ alkyl ether), alkaryl ether, or fluoroalkyl ether, for example, —OCH₃, —OCH₂CH₃, —OC₆H₄C(CH₃)₂CH₂C(CH₃)₂CH₃, —OC₆H₄(C₉H₁₉)₂, —OC₁₂H₂₅, —OC₁₄H₂₉, —OC₁₆H₃₃, or —O-Q R_{f} (where Q and R_{f} are as defined supra); and
   n is a number from 1 to 6.

Specific examples of nonionic fluorochemical surfactants include:
C₈F₁₇SO₂N(C₂H₅)CH₂CH₂(OCH₂CH₂)₇OCH₃
C₈F₁₇SO₂N(C₂H₅)CH₂CH₂(OCH₂CH₂)₉OCH₂CH₃
C₇F₁₅SO₂N(CH₃)CH₂CH₂(OCH₂CH₂)₇(OCH₂CH(CH₃))₄OH
C₈F₁₇SO₂N(C₂H₅)CH₂CH₂NHCH₂CH₂(OCH₂CH₂)₉NHC(O)—CH₃
F(CF₂CF₂)ₙCH₂CH₂O(CH₂CH₂O)ₙH
wherein the last formula represents a mixture of compounds in which n is a number of about 2 to 6, and an average value of about 4, and x is about 14.

Fluoroaliphatic nonionic surfactants, including those depicted supra by Formula II, may be prepared using known methods including those methods described in U.S. Pat. No. 2,915,554 (Albrecht et al.). The Albrecht patent discloses the preparation of fluoroaliphatic group-containing nonionic compounds from active hydrogen-containing fluorochemical intermediates, such as fluoroaliphatic alcohols (e.g., R_{f}C₂H₄OH), acids (e.g., R_{f}SO₂N(R)CH₂CO₂H), and sulfonamides (e.g., R_{f}SO₂N(R)H) by reaction of the intermediates with, for example, ethylene oxide to yield, respectively, R_{f}C₂H₄(OC₂H₄)ₙOH, R_{f}SO₂N(R)CH₂CO₂(C₂H₄O)ₙH, and R_{f}SO₂N(R)(C₂H₄O)ₙH, where n is a number greater than about 3 and R is a hydrogen or a lower alkyl group (e.g., from 1 to 6 carbon atoms). Analogous compounds may be prepared by treating the intermediate with propylene oxide. The fluoroaliphatic oligomers disclosed in U.S. Pat. No. 3,787,351 (Olson), and certain fluorinated alcohol-ethylene oxide condensates described in U.S. Pat. No. 2,723,999 (Cowen et al.), whose descriptions are incorporated herein by reference, are also considered useful. fluoroaliphatic group-containing nonionic surfactants containing hydrophobic long-chain hydrocarbon groups may be prepared by reacting a fluoroaliphatic epoxide, such as 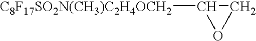
with, for example, an ethoxylated alkylphenol or alcohol, such as CH₃C(CH₃)₂CH₂C(CH₃)₂C₆H₄(OC₂H₄)₉OH or C₁₂H₂₅(OC₂H₄)₉OH, respectively in the presence of BF₃-etherate. They may also be prepared by first converting the ethoxylated alkylphenol or alcohol to a chloride by reaction with thionyl chloride, then reacting the resulting chloride with a fluoroaliphatic sulfonamide containing an active hydrogen, for example C₈F₁₇SO₂NH(CH₃), in the presence of sodium carbonate and potassium iodide.

Useful anionic surfactants include, but are not limited to, alkali metal and (alkyl)ammonium salts of: 1) alkyl sulfates and sulfonates such as sodium dodecyl sulfate and potassium dodecanesulfonate; 2) sulfates of polyethoxylated derivatives of straight or branched chain aliphatic alcohols and carboxylic acids; 3) alkylbenzene or alkylnaphthalene sulfonates and sulfates such as sodium laurylbenzene-sulfonate; 4) ethoxylated and polyethoxylated alkyl and aralkyl alcohol carboxylates; 5) glycinates such as alkyl sarcosinates and alkyl glycinates; 6) sulfosuccinates including dialkyl sulfosuccinates; 7) isethionate derivatives; 8) N-acyltaurine derivatives such as sodium N methyl-N-oleyltaurate); 9) amine oxides including alkyl and alkylamidoalkyldialkylamine oxides; and 10) alkyl phosphate mono or di-esters such as ethoxylated dodecyl alcohol phosphate ester, sodium salt.

Representative commercial examples of suitable anionic sulfonate surfactants include, for example, sodium lauryl sulfate, available as TEXAPON™ L-100 from Henkel Inc., Wilmington, Del., or as POLYSTEP™ B-3 from Stepan Chemical Co, Northfield, Ill.; sodium 25 lauryl ether sulfate, available as POLYSTEP™ B-12 from Stepan Chemical Co., Northfield, Ill.; ammonium lauryl sulfate, available as STANDAPOL™ A from Henkel Inc., Wilmington, Del.; and sodium dodecyl benzene sulfonate, available as SIPONATE™ DS-10 from Rhone-Poulenc, Inc., Cranberry, N.J., dialkyl sulfosuccinates, having the tradename AEROSOL™ OT, commercially available from Cytec Industries, West Paterson, N.J.; sodium methyl taurate (available under the trade designation NIKKOL™ CMT30 from Nikko Chemicals Co., Tokyo, Japan); secondary alkane sulfonates such as Hostapur™ SAS which is a Sodium (C14-C17) secondary alkane sulfonates (alpha-olefin sulfonates) available from Clariant Corp., Charlotte, N.C.; methyl-2-sulfoalkyl esters such as sodium methyl-2-sulfo(C12-16)ester and disodium 2-sulfo(C12-C16) fatty acid available from Stepan Company under the trade designation ALPHASTE™ PC-48; alkylsulfoacetates and alkylsulfosuccinates available as sodium laurylsulfoacetate (under the trade designation LANTHANOL™ LAL) and disodiumlaurethsulfosuccinate (STEPANMILD™ SL3), both from Stepan Company; alkylsulfates such as ammoniumlauryl sulfate commercially available under the trade designation STEPANOL™ AM from Stepan Company.

Representative commercial examples of suitable anionic phosphate surfactants include a mixture of mono-, di- and tri-(alkyltetraglycolether)-o-phosphoric acid esters generally referred to as trilaureth-4-phosphate commercially available under the trade designation HOSTAPHAT™ 340KL from Clariant Corp., as well as PPG-5 cetyl 10 phosphate available under the trade designation CRODAPHOS™ SG from Croda Inc., Parsipanny, N.J.

Representative commercial examples of suitable anionic amine oxide surfactants those commercially available under the trade designations AMMONYX™ LO, LMDO, and CO, which are lauryldimethylamine oxide, laurylamidopropyldimethylamine oxide, and cetyl amine oxide, all from Stepan Company.

Examples of useful amphoteric surfactants include alkyldimethyl amine oxides, alkylcarboxamidoalkylenedimethyl amine oxides, aminopropionates, sulfobetaines, alkyl betaines, alkylamidobetaines, dihydroxyethyl glycinates, imidazoline acetates, imidazoline propionates, ammonium carboxylate and ammonium sulfonate amphoterics and imidazoline sulfonates.

Representative commercial examples amphoteric surfactants include certain betaines such as cocobetaine and cocamidopropyl betaine (commercially available under the trade designations MACKAM™ CB-35 and MACKAM™ L from McIntyre Group Ltd., University Park, Ill.); monoacetates such as sodium lauroamphoacetate; diacetates such as disodium lauroamphoacetate; amino- and alkylamino-propionates such as lauraminopropionic acid (commercially available under the trade designations MACKAM 1L, MACKAM™ 2L, and MACKAM™ 151L, respectively, from McIntyre Group Ltd.) and cocamidopropylhydroxysultaine (commercially available as MACKAM™ 50-SB from McIntyre Group Ltd.).

The hydrophilic article may be prepared by combining the surfactant and the adhesive and coating the mixture onto the thermoplastic polymer layer. The surfactant is used in an amount sufficient to render the surface of the thermoplastic polymer layer hydrophilic upon migration of the surfactant. The surfactant is typically used in an amount of at least about 3 wt. % based on the weight of the adhesive layer and more preferably in an amount of at least about 5 wt. %. The maximum amount of the surfactant is not critical; however, in case of a hydrophilic article consisting of only one layer of thermoplastic polymer, it is preferred to use the lowest amount possible so as not to impair the mechanical properties of the thermoplastic polymer layer. Generally, the amount of surfactant is between about 5 wt. % and 40 wt. %, and more preferably between about 15 wt. % and 30 wt. %.

Any adhesive suitable for use with thermoplastic polymers, that can also serve as a reservoir for surfactants, and that is non-reactive toward the surfactants, can be used in the present invention. Adhesives can include hot melt adhesives, actinic radiation reactive adhesives, and the like. The adhesives can be solvent-based adhesives, 100% solids adhesives, or latex-based adhesives. Reference may be made to Handbook of Pressure Sensitive Adhesive Technology, Second Edition, D. Satas, Editor, Van Nostrand, Rheinhold, 1989. Preferably the adhesive is a pressure sensitive adhesive. “Pressure sensitive adhesive” means an adhesive that is aggressively and permanently tacky at room temperature and firmly adheres to a variety of dissimilar surfaces upon mere contact without the need of more than finger or hand pressure, and has a sufficiently cohesive holding and elastic nature so that they can be handled with the fingers and removed from smooth surfaces without leaving a residue.

Suitable pressure sensitive adhesives include, for example, those based on natural rubbers, synthetic rubbers, styrene block copolymers, polyvinyl ethers, poly (meth)acrylates (including both acrylates and methacrylates), polyurethanes, polyureas, polyolefins, and silicones. The pressure sensitive adhesive may comprise an inherently tacky material, or if desired, tackifiers may be added to a tacky or non-tacky base material to form the pressure sensitive adhesive. Useful tackifiers include, for example, rosin ester resins, aromatic hydrocarbon resins, aliphatic hydrocarbon resins, and terpene resins. Other materials can be added for special purposes, including, for example, plasticizers, hydrogenated butyl rubber, glass beads, conductive particles, filler, dyes, pigments, and combinations thereof.

Pressure sensitive adhesives are commercially available from a number of sources including, for example, 3M Company, Saint Paul, Minn. Further examples of useful pressure sensitive adhesives include those generally described in U.S. Pat. No. 4,112,213 (Waldman); U.S. Pat. No. 4,917,928 (Heinecke); U.S. Pat. No. 4,917,929 (Heinecke); U.S. Pat. No. 5,141,790 (Calhoun); U.S. Pat. No. 5,045,386 (Stan et al.); U.S. Pat. No. 5,229,207 (Paquette et al.); U.S. Pat. No. 5,296,277 (Wilson et al.); U.S. Pat. No. 5,670,557 (Dietz et al.); and U.S. Pat. No. 6,232,366 (Wang et al.); the disclosures of which as incorporated herein by reference.

The pressure sensitive adhesive layer may have any thickness. For example, the pressure sensitive adhesive layer may have a thickness in a range of from at least 25, 100, or 250 micrometers up to and including 500, 1000, or 2500 micrometers or even more.

Depending on the specific thermoplastic polymer layer chosen and intended application, the pressure sensitive adhesive layer may be selected such that, it cannot be mechanically separated from the thermoplastic polymer layer without damaging the thermoplastic polymer layer. This may be desirable, for example, in the case that two thermoplastic polymer layers are bonded together by the pressure sensitive adhesive layer.

The pressure sensitive adhesive layer may be continuous, for example, as a continuous adhesive film or a continuous or coating on fibers at one major surface of the fabric. Alternatively, the pressure sensitive adhesive layer can be a discontinuous layer. In one embodiment, the pressure sensitive adhesive layer may have the shape of an alphanumeric character or graphic image. Suitable methods for applying the pressure sensitive adhesive layer include, for example, roll coating, gravure coating, curtain coating, spray coating, screen printing, with the method typically chosen based on the type of coating desired.

The hydrophilic article may further comprise an optional substrate that may be any solid material, and may have any shape. Suitable substrate materials include, for example, ceramics (e.g., tile, masonry), glass (e.g., windows), metal, cardboard, fabrics, and polymer films (e.g., coated or uncoated polymer films). More specifically, the substrate may be, for example, a motor vehicle, building, window, billboard, boat, wall, floor, door, or a combination thereof.

In one embodiment, the substrate may be a release liner, for example, to protect the adhesive before usage. Examples of release liners include silicone coated kraft paper, silicone coated polyethylene coated paper, silicone coated or non-coated polymeric materials such as polyethylene or polypropylene, as well as the aforementioned base materials coated with polymeric release agents such as silicone urea, urethanes, and long chain alkyl acrylates, such as generally described in U.S. Pat. No. 3,997,702 (Schurb et al.); U.S. Pat. No. 4,313,988 (Koshar et al.); U.S. Pat. No. 4,614,667 (Larson et al.); U.S. Pat. No. 5,202,190 (Kantner et al.); and U.S. Pat. No. 5,290,615 (Tushaus et al.); the disclosures of which are incorporated by reference herein. Suitable commercially available release liners include those available under the trade designation “POLYSLIK” from Rexam Release of Oakbrook, Ill., and under the trade designation “EXHERE” from P.H. Glatfelter Company of Spring Grove, Pa.

In another embodiment, the substrate may be a polymer layer which may be the same as, or different from, the first polymer layer. In this embodiment, the hydrophilic article may be a multilayer hydrophilic article having little or no tackiness on exterior surfaces. The resultant hydrophilic article may be thus used, for example, for any use known for hydrophilic articles, but will typically have increased hydrophilicity compared to the component thermoplastic polymers from which it is made. For example, a hydrophilic article may be prepared by bonding two layers of thermoplastic polymer with pressure sensitive adhesive comprising at least 3 percent by weight of at least one surfactant.

The hydrophilic article is particularly useful as an ink receptive substrate that comprises a thermoplastic polymer layer, and an adhesive layer having one or more surfactants dispersed therein. The adhesive layer may be used for affixing the ink-receptive substrate to a supporting surface such as a wall, a floor, or a ceiling of a building, a sidewall of a truck, a billboard, or any other location where an excellent quality image graphic can be displayed for education, entertainment, or information. Alternatively, the ink receptive substrate may comprise two thermoplastic polymer layers, an adhesive layer disposed therebetween, with the adhesive layer having one or more surfactants dispersed therein.

Some features of ink receptor media of the invention are that they have a large capacity to absorb ink, provide rapid ink drying times, provide sharp delineation of deposited drop edges in inkjet printed colors, provide good color density, provide waterfastness to the applied ink, are UV and chemically stable, are abrasion resistant, are mechanically flexible, and provide excellent adherence to a substrate. In some embodiments of the invention, optically clear ink receptor coatings may be achieved.

In accordance with the method of the present invention, the ink receptive substrate may be provided in an image-wise fashion with ink. By the term “image-wise applying” in connection with the invention is meant that an ink pattern is applied representing information such as signs, graphs, drawings, images, text or any combination thereof. The ink that is applied to the ink receptive substrate can be any type of ink commonly used in the art. For example, the ink can be aqueous based as well as solvent based. Preferably the ink is aqueous based. Further, the ink may be based on dyes that are dissolved in the ink or that are present in the ink as finely dispersed pigments. The image-wise application of the ink on the substrates of the invention conveniently proceeds by means of an inkjet printer.

Commercially available inkjet printers that can be used in connection with the invention include for example the Hewlett Packard printers HP 855 desk jet, HP 870 desk jet, HP 2000c desk jet, HP 2500 Design Jet and the Encad™ printers Novajet™ IV and Novajet™ Pro.

While the imaging major surface is not covered before imaging, after imaging, an optional layer may be applied to that imaged major surface to protect and enhance the image quality of the image on the receptor. Nonlimiting examples of optional layers are overlaminates and protective clear coatings commercially available from Minnesota Mining and Manufacturing Company from its Commercial Graphics Division and those disclosed in U.S. Pat. No. 5,681,660 (Bull et al.). Other products known to those skilled in the art can also be used.

The invention is further illustrated by means of the following examples without the intention to limit the invention thereto.

### EXAMPLES

These examples are merely for illustrative purposes only and are not meant to be limiting on the scope of the appended claims. All parts, percentages, ratios, etc. in the examples and the rest of the specification are by weight, unless noted otherwise. Solvents and other reagents used were obtained from Aldrich Chemical Company; Milwaukee, Wis. unless otherwise noted.

Test Methods

Surface Wetting Screening Test

This test is a qualitative measure of the surface wetting ability of a surface. A set volume of 10 microliters of deionized water was slowly deposited from a syringe directly onto the top surface of the material to be tested and observation was made whether the water droplet wets the surface or beads up during a period of about 15 minutes. The results are presented as “Wets” if the droplet wets the surface or “Beads Up” if the droplet beads up on the surface.

Contact Angle Measurement

Static contact angle (θ) was measured using a VCA 2500 XE (AST Products). A 2 microliter droplet of deionized water was slowly deposited from a syringe onto the top surface of the target substrate and the contact angle was measured after 3 minutes by video capture.

XPS/ESCA

X-ray photoelectron spectroscopy was performed using TA-M ESCA with a non-monochromatized A1 source; photoemission was detected at an angle of 90° with respect to the surface normal.

Table of Abbreviations

| Abbreviation | |
|---|---|
| or Trade | |
| Designation | Description |
| Adhesive-1 | A water-based latex adhesive prepared generally according to the |
| | procedure described in WO 01/81491 A1 (Loncar), Examples 6 and 7, by |
| | blending: 42.7 parts by weight of a dispersion of hollow tacky |
| | microspheres prepared as generally described in WO 92/13924 |
| | (Steelman, et al.), Example 1; 48.8 parts of an acrylate pressure-sensitive |
| | adhesive commercially available from 3M Company under the trade |
| | designation “FASTBOND 49”; 0.9 part by weight of an acrylic resin |
| | solution available from Rohm & Haas Company, Philadelphia, |
| | Pennsylvania, under the trade designation “ACRYSOL ASE-60”; 2.5 |
| | parts by weight of n-octanol; 5 parts by weight of a mixture of 58 parts of |
| | water, 3 parts of lithium hydroxide monohydrate, and 39 parts of |
| | ammonium hydroxide; and 0.1 part by weight of a defoamer available |
| | under the trade designation “FOAMASTER JMY” from Cognis Corp., |
| | Ambler, Pennsylvania; |
| Additive-1 | poly(oxy-1,2-ethanediyl), -[3,5-dimethyl-1-(2-methylpropyl) |
| | hexyl]-[2-[methyl [(nonafluorobutyl) sulfonyl] amino] ethoxy] with a |
| | molecular weight of approximately 1000 g/mol, prepared as described in |
| | the Synthesis Method below. |
| Additive-2 | Aerosol OT-100, sodium dioctylsulfosuccinate |
| | C₈H₁₇OOCCH₂CH(SO₃Na)COOC₈H₁₇ from CYTEC Ind., West |
| | Patterson, NJ |
| Additive-3 | Ethoquad C25, 95% solids in water from Akzo Nobel, Chicago, IL |
| PP Film | Polypropylene (PP) extruded film at 0.10 millimeters thick, using Fina |
| | PP3376 available from Atofina Inc., Houston, TX. |
| PE Film-1 | Low density polyethylene (LDPE) blown film, 0.10 millimeters thick, cut |
| | from a zipper lock sample bag available from VWR Scientific Products, |
| | So. Plainfield, NJ. |
| PE Film-2 | Microreplicated LDPE channel film having a total thickness of 0.51 |
| | millimeters. Details regarding the size, shape and dimensions of channels |
| | may be found in US 2003/0102076 A1 Example 2, U.S. Pat. No. 6,531,205 |
| | (Johnston et al.) and U.S. Pat. No. 6,080,243 (Insley et al), incorporated herein by |
| | reference. |
| PUR Film | Polyurethane (PUR) extruded film at 0.10 millimeters thick, using |
| | ESTANE 58329 available from Noveon, Inc., Cleveland, OH. |
| PS Film | Polystyrene (PS) extruded film at 0.10 millimeters thick using STYRON |
| | 666H Resin from Dow Chemical Company, Midland, MI. |
| Microporous | A sample of a polypropylene based microporous membrane prepared by |
| Film | the thermally induced phase separation technique (U.S. Pat. No. 4,539,256 - |
| | Shipman et al., U.S. Pat. No. 4,726,989; U.S. Pat. No. 5,120,594 - Mrozinski). Sample was |
| | 0.18 millimeters thick, 40% porosity, and with 0.8 micrometer pore size. |
| Fabric-1 | Nonwoven flashspun High Density Polyethylene fabric, Product Number |
| | “TYVEK” 1042B, having a basis weight of 40.7 grams/square meter |
| | (g/m²), available from E.I. du Pont de Nemours and Company, |
| | Wilmington, DE. |
| Fabric-2 | A meltblown polyethylene fabric having a basis weight of 86 g/m² and a |
| | thickness of 0.20 mm, obtained under the trade designation “TYPE |
| | TM07-27-98-02” from TransWeb, LLC, Vineland, New Jersey. |
| Fabric-3 | A spunlaced nonwoven fabric prepared by hydroentangling an air-laid |
| | web consisting of 30 percent by weight of rayon fibers (1.5 denier × 3.8 cm |
| | long, trade designation “Type B649”, obtained from Lenzing Fiber |
| | Corporation, Lowland, Tennessee), 60 of polyester staple fibers (2.0 |
| | denier × 3.8 cm long, trade designation “Type T224”, obtained from |
| | KoSa B. V., Houston, Texas), and 10 weight percent of PET/coPET |
| | sheath/core bicomponent fibers (2.0 denier × 3.8 cm long, trade |
| | designation “Celbond Type T254”, obtained from KoSa B. V.). |
| | A conventional hydraulic entangling system consisting of 6 |
| | manifolds/jets (3 above and 3 below) was used. The basic operating |
| | procedure is described in U.S. Pat. No. 5,389,202 (Everhart et al.), the |
| | disclosure of which is incorporated herein by reference. Each manifold |
| | had an orifice diameter of 120 microns. Orifices were positioned in a |
| | single row at spacing of about 16 orifices per linear centimeter of |
| | manifold. Manifold water pressure was successively ramped up to 127 kg/cm², |
| | which generated high energy fine columnar water jets. The air |
| | laid web was passed under the manifolds at a line speed of about 10 m/min, |
| | and then dried. Prior to hydroentangling, a carded web was first |
| | passed through an oven to melt the sheath component of the bicomponent |
| | fibers thereby providing a somewhat cohesive air-laid web. The |
| | nonwoven fabric had a basis weight of 85 g/m² and a thickness of 0.5 mm. |
| Fabric-4 | Polypropylene meltblown microfiber nonwoven fabric, prepared as |
| | described in Wente, Van A., “Superfine Thermoplastic Fibers” in |
| | Industrial Engineering Chemistry, Vol. 48, page 1342 et seq. (1956), or in |
| | Report No. 4364 of the Naval Research Laboratories, published May 25, |
| | 1954, entitled “Manufacture of Superfine Organic Fibers,” by Wente, V. A.; |
| | Boone, C. D.; and Fluharty, E. L., having a basis weight of 21.5 g/m² |
| | and an average effective fiber diameter (EFD) of 20 microns. The |
| | average EFD of the web was calculated using an air flow rate of 32 L/min |
| | according to the method described in Davies, C. N., “The Separation of |
| | Airborne Dust and Particles,” Institution of Mechanical Engineers, |
| | London, Proceedings 1B, 1952. |
| Fabric-5 | Refers to a multicomponent fiber web having a basis weight of 100 g/m² |
| | and a thickness of 0.30 mm prepared by melt blown fiber production |
| | techniques according generally to the procedure of Backing Sample 16 in |
| | U.S. Pat. No. 6,107,219 (Joseph), the disclosure of which is |
| | incorporated herein by reference. The multicomponent fibers had a hot |
| | melt adhesive component (20 percent by weight) and a polyurethane |
| | component (80 percent by weight). |
| Release Liner | ScotchPak TPK 6752 PET release liner of with release agent on both |
| | sides, available from 3M, Inc., St. Paul, MN. |
| PET | Poly(ethylene terephthalate) |

Synthesis Method of Additive-1
Step 1:

In a glass reaction vessel equipped with stirbar was placed 856.9 grams of Tergitol TMN-10 (Union Carbide, Danbury Conn., 90% solids). The TMN-10 was dehydrated by heating at 120° C. and vacuum (˜25 mm) to provide 779.4 grams of 100% solids material. A sample was removed leaving 747.4 grams (1.13 moles). The vessel was fitted with a reflux condenser and a sodium hydroxide scrubber consisting of two 1 L flasks connected in series, the second containing ˜500 milliliters of a 20% sodium hydroxide solution into which was placed a bubbler tube. The vessel was heated to 65° C. with an oil bath and thionyl chloride (156.22 grams, 1.313 mole, 1.16 stoichiometric ratio with respect to the TMN-10) was added over about a 1 hour period. The reaction temperature was ˜55° C. upon completion of the addition. The heating bath was raised to 75° C. for about 30 minutes, then to 95° C. A nitrogen inlet was added to the vessel and nitrogen was passed over through the reaction vessel at a rate of about 10 bubbles/second and the reaction was allowed to heat overnight. The reaction mixture was heated to 140° C. for 2 h at ˜25 mm vacuum to remove any volatiles. The reaction yielded 767.6 grams of product (99.3% yield). The ¹H and ¹³C NMR spectra were consistent with the structure of the desired product.

Step 2:

In a glass reaction vessel was placed 691.0 grams (1.016 moles) of the product from Step 1 above. A reflux condenser was attached, the system was quickly purged with nitrogen, and 322.5 grams (1.030 moles) of C₄F₉SO₂N(CH₃)H was added. The mixture was heated to 120° C. with stirring using a silicone oil bath, and 131.0 grams (1.236 moles) of powdered Na₂CO₃ (purchased from MCB Chemicals) was added in portions, which caused foaming to occur. After the foaming had subsided, 10.7 grams (0.065 moles) of KI (purchased from EM Science) was added, and the reaction mixture was heated at 120° C. with stirring under nitrogen. After 18 hours, a 1.0 gram aliquot was withdrawn from the reaction mixture and diluted with 1.5 g of 2-butanone. Analysis of this mixture by GLC indicated complete consumption of C₄F₉SO₂N(CH₃)H. A second 1.0 g aliquot was diluted with 1.5 g of 2-butanone, and the resultant mixture was filtered through Celite, concentrated under reduced pressure and a ¹³C NMR spectrum confirmed the absence of starting material from Step 1. The temperature of the reaction mixture was reduced to 95° C., and 800 milliliters of hot (55° C.) tap water was added. The mixture was transferred to a separatory funnel, the lower aqueous layer was separated, and the organic phase was washed with was washed with three additional 500 milliliter portions of hot tap water. The organic phase was finally washed with one 800 milliliter portion of 50% saturated aqueous NaCl, and the pH of the aqueous phase was adjusted to approximately 7 with 10% aqueous H₂SO₄. The layers were separated, and the organic layer was at 140° C. under vacuum to give 973.3 grams of an amber liquid suspending a small amount of insoluble material. Solids were permitted to settle from the product, and the clear amber liquid was decanted. The ¹H and ¹³C NMR spectra were consistent with the structure of the desired product.

### Example 1

Part I: Preparation of Adhesive Sample

A mixture of Adhesive-1 and 6.7% by weight of Additive-1 was prepared and coated at a thickness of 0.76 millimeters with a doctor knife onto a Release Liner, and allowed to dry at room temperature for three days to give a dry adhesive thickness of approximately 0.30 millimeters. The final concentration of Additive-1 in the dried adhesive was approximately 15% by weight.

Part II: Preparation and Testing of Laminates

Three tapes of the adhesive sample prepared in Part I above were prepared by laminating adhesive samples to three samples of PE Film-1. The release liners were removed from each of these tapes and the adhesive sides of each tape was laminated to a glass slide to form a 3 layer laminate. One laminate was placed to age in an 80° C. oven, the second laminate was placed to age in a 40° C. oven, and the third laminate was aged at room temperature. The sample laminates were tested after 3 days by the Surface Wetting Screening Test using the test method described above. The results are shown in Table 1. The contact angle was measured for these laminates after 6 days of heating followed by 6 months at room temperature using the Contact Angle Measurement test method described above. These results are shown in Table 1.

### Comparative Example C1

Part I: Preparation of Adhesive Sample

Adhesive-1 with no additive was coated as described for Example 1, Part I above.

Part II: Preparation and Testing of Laminates

Three tapes of the adhesive sample prepared in Part I above were prepared by laminating adhesive samples to three samples of PE Film-1. The release liners were removed from each of these tapes and the adhesive sides of each tape was laminated to a glass slide to form a 3-layer laminate. One laminate was placed to age in an 80° C. oven, the second laminate was placed to age in a 40° C. oven, and the third laminate was aged at room temperature. The sample laminates were tested over time by the Surface Wetting Screening Test using the test method described above. The results are shown in Table 1. The contact angle was measured for these laminates after 6 days of heating followed by 6 months at room temperature using the Contact Angle Measurement test method described above. These results are shown in Table 1.

TABLE 1

| | | | Contact Angle (°) |
|---|---|---|---|
| | | | after 6 days of |
| | | | Aging Followed |
| | | | by 6 Months at |
| | | Surface Wetting | Room |
| Example | Aging Temperature | after 3 days | Temperature |
| 1 | Room Temperature | Beads Up | 72 |
| 1 | 40° C. | Wets | ˜0 |
| 1 | 80° C. | Wets | ˜0 |
| C1 | Room Temperature | Beads Up | 85 |
| C1 | 40° C. | Beads Up | 85 |
| C1 | 80° C. | Beads Up | 85 |

### Example 2

Part I: Preparation of Adhesive Sample

A mixture of Adhesive-1 and 6.7% by weight of Additive-1 was prepared and coated at a thickness of 0.64 millimeters with a doctor knife onto a Release Liner, and allowed to dry at room temperature for three days to give a dry adhesive thickness of approximately 0.25 millimeters. The final concentration of Additive-1 in the dried adhesive was approximately 15% by weight.

Part II: Preparation and Testing of Laminates

Three tapes of the adhesive sample prepared in Part I above were prepared by laminating adhesive samples to three samples of PE Film-2. The release liners were removed from each of these tapes and the adhesive sides of each tape was laminated to a glass slide to form a 3-layer laminate. One laminate was placed to age in an 80° C. oven, the second laminate was placed to age in a 40° C. oven, and the third laminate was aged at room temperature. The contact angle was measured for these laminates before and after 15 days of aging at these temperatures and the initial and after aging contact angles were all 145° due to the microstructured surface of the film. However the laminate aged at 80° C. when tested over time by the Surface Wetting Screening Test using the test method described above, was shown to wet after 2 days.

### Comparative Example C2

Part I: Preparation of Adhesive Sample

Adhesive-1 with no additive was coated as described for Example 2, Part I above.

Part II: Preparation and Testing of Laminates

Three tapes of the adhesive sample prepared in Part I above were prepared by laminating adhesive samples to three samples of PE Film-2. The release liners were removed from each of these tapes and the adhesive sides of each tape was laminated to a glass slide to form a 3 layer laminate. One laminate was placed to age in an 80° C. oven, the second laminate was placed to age in a 40° C. oven, and the third laminate was aged at room temperature. The contact angle was measured for these laminates before and after 15 days of aging at these temperatures and the initial and after aging contact angles were all 145° due to the microstructured surface of the film. However the laminate aged at 80° C. when tested over time by the Surface Wetting Screening Test using the test method described above, was shown to wet after 2 days.

### Example 3

Part I: Preparation of Adhesive Sample

Same as Example 2.

Part II: Preparation and Testing of Laminates

Three tapes of the adhesive sample prepared in Part I above were prepared by laminating adhesive samples to three samples of PP Film. The release liners were removed from each of these tapes and the adhesive sides of each tape was laminated to a glass slide to form a 3-layer laminate. One laminate was placed to age in an 80° C. oven, the second laminate was placed to age in a 40° C. oven, and the third laminate was aged at room temperature. The contact angle was measured for these laminates before and after aging. The results are shown in Table 2.

### Comparative Example C3

Part I: Preparation of Adhesive Sample

Same as Comparative Example C2.

Part II: Preparation and Testing of Laminates

Three tapes of the adhesive sample prepared in Part I above were prepared by laminating adhesive samples to three samples of PP Film. The release liners were removed from each of these tapes and the adhesive sides of each tape was laminated to a glass slide to form a 3-layer laminate. One laminate was placed to age in an 80° C. oven, the second laminate was placed to age in a 40° C. oven, and the third laminate was aged at room temperature. The contact angle was measured for these laminates before and after aging. The results are shown in Table 2.

TABLE 2

| | Aging | Initial Contact | Aging Time | Contact Angle |
|---|---|---|---|---|
| Example | Temperature | Angle | (days) | after Aging |
| 3 | Room | 90 | 15 | 90 |
| | Temperature | | | |
| 3 | 40° C. | 90 | 15 | 90 |
| 3 | 80° C. | 90 | 10 | 75 |
| C3 | Room | 90 | 15 | 90 |
| | Temperature | | | |
| C3 | 40° C. | 90 | 15 | 90 |
| C3 | 80° C. | 90 | 10 | 90 |

### Example 4

Part I: Preparation of Adhesive Sample

A mixture of Adhesive-1 and 10% by weight of Additive-1 was prepared and coated at a thickness of 0.15 millimeters with a doctor knife onto a release liner, and allowed to dry at room temperature for three days to give a dry adhesive thickness of approximately 0.060 millimeters. The final concentration of Additive-1 in the dried adhesive was approximately 21.7% by weight.

Part II: Preparation and Testing of Laminates

Two tapes of the adhesive sample prepared in Part I above were prepared by laminating adhesive samples to three samples of PUR Film. The release liners were removed from each of these tapes and the adhesive sides of each tape was laminated to a glass slide to form a 3-layer laminate. One laminate was placed to age in an 85° C. oven, the second laminate was aged at room temperature. The sample laminates were tested after 25 days by the Surface Wetting Screening Test using the test method described above. The results are shown in Table 3.

### Comparative Example C4

Part I: Preparation of Adhesive Sample

Adhesive-1 with no additive was coated as described for Example 4, Part I above.

Part II: Preparation and Testing of Laminates

Two tapes of the adhesive sample prepared in Part I above were prepared by laminating adhesive samples to three samples of PUR Film. The release liners were removed from each of these tapes and the adhesive sides of each tape was laminated to a glass slide to form a 3 layer laminate. One laminate was placed to age in an 85° C. oven, the second laminate was aged at room temperature. The sample laminates were tested after 25 days by the Surface Wetting Screening Test using the test method described above. The results are shown in Table 3.

TABLE 3

| | | Aging Time | |
|---|---|---|---|
| Example | Aging Temperature | (days) | Surface Wetting |
| 4 | Room Temperature | 25 | Beads Up |
| 4 | 85° C. | 6 | Wets |
| C4 | Room Temperature | 25 | Beads Up |
| C4 | 85° C. | 25 | Beads Up |

### Example 5

Part I: Preparation of Adhesive Sample

Same as Example 4.

Part II: Preparation and Testing of Laminates

Two tapes of the adhesive sample prepared in Part I above were prepared by laminating adhesive samples to three samples of PS Film. The release liners were removed from each of these tapes and the adhesive sides of each tape was laminated to a glass slide to form a 3 layer laminate. One laminate was placed to age in an 85° C. oven, the second laminate was aged at room temperature. The sample laminates were tested daily for 20 days by the Surface Wetting Screening Test using the test method described above. The results are shown in Table 4.

### Comparative Example C5

Part I: Preparation of Adhesive Sample

Same as Comparative Example C4.

Part II: Preparation and Testing of Laminates

Two tapes of the adhesive sample prepared in Part I above were-prepared by laminating adhesive samples to three samples of PS Film. The release liners were removed from each of these tapes and the adhesive sides of each tape was laminated to a glass slide to form a 3 layer laminate. One laminate was placed to age in an 85° C. oven, the second laminate was aged at room temperature. The sample laminates were tested daily for 20 days by the Surface Wetting Screening Test using the test method described above. The results are shown in Table 4.

TABLE 4

| | | Aging Time | |
|---|---|---|---|
| Example | Aging Temperature | (days) | Surface Wetting |
| 5 | Room Temperature | 9 | Wets |
| 5 | 85° C. | 20 | Beads Up* |
| C5 | Room Temperature | 20 | Beads Up |
| C5 | 85° C. | 20 | Beads Up* |

*Samples aged at 85° C. changed from clear to a yellow color

### Example 6

Part I: Preparation of Adhesive Sample

Same as Example 1.

Part II: Preparation and Testing of Laminates

Three tapes of the adhesive sample prepared in Part I above were prepared by laminating adhesive samples to three samples of Microporous Film. The release liners were removed from each of these tapes and the adhesive sides of each tape was laminated to a glass slide to form a 3-layer laminate. One laminate was placed to age in an 80° C. oven, the second laminate was placed to age in a 40° C. oven, and the third laminate was aged at room temperature. The sample laminates were tested after 1 day by the Surface Wetting Screening Test using the test method described above. The results are shown in Table 5.

### Comparative Example C6

Part I: Preparation of Adhesive Sample

Same as Comparative Example C1.

Part II: Preparation and Testing of Laminates

Three tapes of the adhesive sample prepared in Part I above were prepared by laminating adhesive samples to three samples of Microporous Film. The release liners were removed from each of these tapes and the adhesive sides of each tape was laminated to a glass slide to form a 3 layer laminate. One laminate was placed to age in an 80° C. oven, the second laminate was placed to age in a 40° C. oven, and the third laminate was aged at room temperature. The sample laminates were tested after 1 day by the Surface Wetting Screening Test using the test method described above. The results are shown in Table 5.

TABLE 5

| Example | Aging Temperature | Surface Wetting after 1 day |
|---|---|---|
| 6 | Room Temperature | Wets |
| 6 | 40° C. | Wets |
| 6 | 80° C. | Wets |
| C6 | Room Temperature | Beads Up |
| C6 | 40° C. | Beads Up |
| C6 | 80° C. | Beads Up |

### Example 7

Part I: Preparation of Adhesive Sample

Same as Example 4.

Part II: Preparation and Testing of Laminates

Two tapes of the adhesive sample prepared in Part I above were prepared by laminating adhesive samples to three samples of Fabric-1. The release liners were removed from each of these tapes and the adhesive sides of each tape was laminated to a glass slide to form a 3 layer laminate. One laminate was placed to age in an 85° C. oven, the second laminate was aged at room temperature; The sample laminates were tested daily for 20 days by the Surface Wetting Screening Test using the test method described above. The results are shown in Table 6.

### Comparative Example C7

Part I: Preparation of Adhesive Sample

Same as Comparative Example C4.

Part II: Preparation and Testing of Laminates

Two tapes of the adhesive sample prepared in Part I above were prepared by laminating adhesive samples to three samples of Fabric-1. The release liners were removed from each of these tapes and the adhesive sides of each tape was laminated to a glass slide to form a 3-layer laminate. One laminate was placed to age in an 85° C. oven, the second laminate was aged at room temperature. The sample laminates were tested daily for 20 days by the Surface Wetting Screening Test using the test method described above. The results are shown in Table 6.

TABLE 6

| | | Aging Time | |
|---|---|---|---|
| Example | Aging Temperature | (days) | Surface Wetting |
| 7 | Room Temperature | 6 | Wets |
| 7 | 85° C. | 20 | Beads Up |
| C7 | Room Temperature | 20 | Beads Up |
| C7 | 85° C. | 20 | Beads Up |

### Example 8

Part I: Preparation of Adhesive Sample

Same as Example 4.

Part II: Preparation and Testing of Laminates

Two tapes of the adhesive sample prepared in Part I above were prepared by laminating adhesive samples to three samples of Fabric-2. The release liners were removed from each of these tapes and the adhesive sides of each tape was laminated to a glass slide to form a 3-layer laminate. One laminate was placed to age in an 85° C. oven, the second laminate was aged at room temperature. The sample laminates were tested daily for 20-27 days by the Surface Wetting Screening Test using the test method described above. The results are shown in Table 7.

### Comparative Example C8

Part I: Preparation of Adhesive Sample

Same as Comparative Example C4.

Part II: Preparation and Testing of Laminates

Two tapes of the adhesive sample prepared in Part I above were prepared by laminating adhesive samples to three samples of Fabric-2. The release liners were removed from each of these tapes and the adhesive sides of each tape was laminated to a glass slide to form a 3 layer laminate. One laminate was placed to age in an 85° C. oven, the second laminate was aged at room temperature. The sample laminates were tested daily for 20-27 days by the Surface Wetting Screening Test using the test method described above. The results are shown in Table 7.

TABLE 7

| | | Aging Time | |
|---|---|---|---|
| Example | Aging Temperature | (days) | Surface Wetting |
| 8 | Room Temperature | 27 | Wets |
| 8 | 85° C. | 6 | Wets |
| C8 | Room Temperature | 27 | Beads Up |
| C8 | 85° C. | 20 | Beads Up |

### Example 9

Part I: Preparation of Adhesive Sample

Same as Example 4.

Part II: Preparation and Testing of Laminates

Two tapes of the adhesive sample prepared in Part I above were prepared by laminating adhesive samples to three samples of Fabric-3. The release liners were removed from each of these tapes and the adhesive sides of each tape was laminated to a glass slide to form a 3-layer laminate. One laminate was placed to age in an 85° C. oven, the second laminate was aged at room temperature. The sample laminates were tested daily for up to 27 days by the Surface Wetting Screening Test using the test method described above. The results are shown in Table 8.

### Comparative Example C9

Part I: Preparation of Adhesive Sample

Same as Comparative Example C4.

Part II: Preparation and Testing of Laminates

Two tapes of the adhesive sample prepared in Part I above were prepared by laminating adhesive samples to three samples of Fabric-3. The release liners were removed from each of these tapes and the adhesive sides of each tape was laminated to a glass slide to form a 3 layer laminate. One laminate was placed to age in an 85° C. oven, the second laminate was aged at room temperature. The sample laminates were tested daily for up to 27 days by the Surface Wetting Screening Test using the test method described above. The results are shown in Table 8.

TABLE 8

| | | Aging Time | |
|---|---|---|---|
| Example | Aging Temperature | (days) | Surface Wetting |
| 9 | Room Temperature | 27* | Wets |
| 9 | 85° C. | 2 | Wets |
| C9 | Room Temperature | 27* | Wets |
| C9 | 85° C. | 27 | Beads Up |

*these samples initially wet and retain their wetting ability through the 27 aging cycle

### Example 10

Part I: Preparation of Adhesive Sample

Same as Example 4.

Part II: Preparation and Testing of Laminates

Two tapes of the adhesive sample prepared in Part I above were prepared by laminating adhesive samples to three samples of Fabric-4. The release liners were removed from each of these tapes and the adhesive sides of each tape was laminated to a glass slide to form a 3-layer laminate. One laminate was placed to age in an 85° C. oven, the second laminate was aged at room temperature. The sample laminates were tested daily for 20-27 days by the Surface Wetting Screening Test using the test method described above. The results are shown in Table 9.

### Comparative Example C10

Part I: Preparation of Adhesive Sample

Same as Comparative Example C4.

Part II: Preparation and Testing of Laminates

Two tapes of the adhesive sample prepared in Part I above were prepared by laminating adhesive samples to three samples of Fabric-4. The release liners were removed from each of these tapes and the adhesive sides of each tape was laminated to a glass slide to form a 3 layer laminate. One laminate was placed to age in an 85° C. oven, the second laminate was aged at room temperature. The sample laminates were tested daily for 20-27 days by the Surface Wetting Screening Test using the test method described above. The results are shown in Table 9.

TABLE 9

| | | Aging Time | |
|---|---|---|---|
| Example | Aging Temperature | (days) | Surface Wetting |
| 10 | Room Temperature | 6 | Wets |
| 10 | 85° C. | 20 | Beads Up |
| C10 | Room Temperature | 27 | Beads Up |
| C10 | 85° C. | 20 | Beads Up |

### Example 11

Part I: Preparation of Adhesive Sample

Same as Example 4.

Part II: Preparation and Testing of Laminates

Two tapes of the adhesive sample prepared in Part I above were prepared by laminating adhesive samples to three samples of Fabric-5. The release liners were removed from each of these tapes and the adhesive sides of each tape was laminated to a glass slide to form a 3-layer laminate. One laminate was placed to age in an 85° C. oven, the second laminate was aged at room temperature. The sample laminates were tested daily for up to 27 days by the Surface Wetting Screening Test using the test method described above. The results are shown in Table 10.

### Comparative Example C11

Part I: Preparation of Adhesive Sample

Same as Comparative Example C4.

Part II: Preparation and Testing of Laminates

Two tapes of the adhesive sample prepared in Part I above were prepared by laminating adhesive samples to three samples of Fabric-5. The release liners were removed from each of these tapes and the adhesive sides of each tape was laminated to a glass slide to form a 3-layer laminate. One laminate was placed to age in an 85° C. oven, the second laminate was aged at room temperature. The sample laminates were tested daily for up to 27 days by the Surface Wetting Screening Test using the test method described above. The results are shown in Table 10.

TABLE 10

| | | | |
|---|---|---|---|
| | | Aging Time | |
| Example | Aging Temperature | (days) | Surface Wetting |

| | | | |
|---|---|---|---|
| 11 | Room Temperature | 12 | Wets |
| 11 | 85° C. | 2 | Wets |
| C11 | Room Temperature | 27 | Beads Up |
| C11 | 85° C. | 12 | Wets |

### Example 12 and Comparative Example C12

Inkjet Printing Testing

For Example 12 the laminate prepared in Example 6 that had been aged at room temperature was printed on using an HP Deskjet 950D water-based printer. For Comparative Example C12 the Microporous Film prepared in Comparative Example C6 that had been aged at room temperature was printed on using an HP Deskjet 950D water-based printer. A significant difference was observed between the Comparative Example C12 and the Example 12 when printing with black ink. In Comparative Example C12, the ink tended to bead up and the image looked very faded. In Example 12, the ink spread out evenly and the image was significantly darker.

### Examples 13-14 and Comparative Examples C13-C14

XPS/ESCA—Surface Analysis:

To confirm the presence of surfactant on the surface of the film specimens, the laminates from Example 1 (Example 13) and Example 6 (Example 14) that had been aged at 80° C. for 7 days and samples of PE Film-1 (Comparative Example C13) and Microporous Film (Comparative Example C14) which had been aged at 80° C. for 7 days prior to testing were submitted for XPS surface analysis. These results are shown in Table 11.

TABLE 11

| | | | | Fluorine |
|---|---|---|---|---|
| | | Carbon | Oxygen | Atomic |
| Example | Sample | Atomic Percent | Atomic Percent | Percent |
| 13 | Example 1 | 67 | 19 | 9.6 |
| C13 | PE Film-1 | 90 | 5.9 | — |
| 14 | Example 6 | 81 | 12 | 3.4 |
| C14 | Microporous | 94 | 5.7 | — |
| | Film | | | |

### Example 15

Part I: Preparation of Adhesive Sample

A mixture of Adhesive-1 and 7.0% by weight of Additive-2 was prepared and coated at a thickness of 0.76 millimeters with a doctor knife onto a Release Liner, and allowed to dry at room temperature for 24 hours to give a dry adhesive thickness of approximately 0.10 millimeters. The final concentration of Additive-2 in the dried adhesive was approximately 15% by weight.

Part II: Preparation and Testing of Laminates

Three tapes of the adhesive sample prepared in Part I above were prepared by laminating adhesive samples to two samples of Microporous Film. The release liners were removed from each of these tapes and the adhesive sides of each tape was laminated to a glass slide to form a 3-layer laminate. One laminate was placed to age in an 80° C. oven, the second laminate was aged at room temperature. The sample laminates were tested after 16 hours by the Surface Wetting Screening Test using the test method described above. The results are shown in Table 12.

### Comparative Example C15

Part I: Preparation of Adhesive Sample

Adhesive-1 with no additive was coated as described for Example 15, Part I above.

Part II: Preparation and Testing of Laminates

Two tapes of the adhesive sample prepared in Part I above were prepared by laminating adhesive samples to three samples of Microporous Film. The release liners were removed from each of these tapes and the adhesive sides of each tape was laminated to a glass slide to form a 3-layer laminate. One laminate was placed to age in an 80° C. oven, the second laminate was aged at room temperature. The sample laminates were tested over time by the Surface Wetting Screening Test using the test method described above. The results are shown in Table 12.

TABLE 12

| | | Surface Wetting after 16 |
|---|---|---|
| Example | Aging Temperature | hours |
| 15 | Room Temperature | Beads Up |
| 15 | 80° C. | Wets |
| C15 | Room Temperature | Beads Up |
| C15 | 80° C. | Beads Up |

### Example 16 and Comparative Example C16

Inkjet Printing Testing

For Example 16 a laminate prepared as in Example 15 that had been aged at 80° C. for 4 days was laminated to a piece of paper and printed on using an HP Deskjet 5550 water-based printer. For Comparative Example C16 a laminate prepared as in Comparative Example C15 that had been aged at 80° C. for 4 days was laminated to a piece of paper and printed on using an HP Deskjet 5550 water-based printer. A significant difference was observed between Comparative Example C16 and Example 16 when printing with black ink. In Example 16, the sample was dry to the touch immediately after printing. In Comparative Example C16, the ink tended to bead up and was wet to the touch 30 minutes after printing and still smeared after 16 hours.

### Example 17

Part I: Preparation of Adhesive Sample

A mixture of Adhesive-1 and 2.0% by weight of Additive-1 was prepared and coated with a doctor knife onto a Release Liner, and allowed to dry at room temperature for 24 hours to give a dry adhesive thickness of approximately 0.10 millimeters. The final concentration of Additive-1 in the dried adhesive was approximately 5% by weight.

Part II: Preparation and Testing of Laminates

A tape of the adhesive sample prepared in Part I above was prepared by laminating the adhesive sample to a sample of Microporous Film. The release liner was removed from this tape and the adhesive side of the tape was laminated to a glass slide to form a 3 layer laminate. The laminate was placed to age in an 80° C. oven. The sample laminate was tested after 3 days by the Surface Wetting Screening Test using the test method described above. The result is shown in Table 13.

### Example 18

Part I: Preparation of Adhesive Sample

A mixture of Adhesive-1 and 1.2% by weight of Additive-1 was prepared and coated with a doctor knife onto a Release Liner, and allowed to dry at room temperature for 24 hours to give a dry-adhesive thickness of approximately 0.10 millimeters. The final concentration of Additive-1 in the dried adhesive was approximately 3% by weight.

Part II: Preparation and Testing of Laminates

A tape of the adhesive sample prepared in Part I above was prepared by laminating the adhesive sample to a sample of Microporous Film. The release liner was removed from the tape and the adhesive side of the tape was laminated to a glass slide to form a 3 layer laminate. The laminate was placed to age in an 80° C. oven. The sample laminate was tested after 3 days by the Surface Wetting Screening Test using the test method described above. The result is shown in Table 13.

### Comparative Example C17

Part I: Preparation of Adhesive Sample

A mixture of Adhesive-1 and 0.47% by weight of Additive-1 was prepared and coated with a doctor knife onto a Release Liner, and allowed to dry at room temperature for 24 hours to give a dry adhesive thickness of approximately 0.10 millimeters. The final concentration of Additive-1 in the dried adhesive was approximately 1% by weight.

Part II: Preparation and Testing of Laminates

A tape of the adhesive sample prepared in Part I above was prepared by laminating the adhesive sample to a sample of Microporous Film. The release liner was removed from the tape and the adhesive side of the tape was laminated to a glass slide to form a 3 layer laminate. The laminate was placed to age in an 80° C. oven. The sample laminate was tested after 3 days by the Surface Wetting Screening Test using the test method described above. The result is shown in Table 13.

### Comparative Example C18

Part I: Preparation of Adhesive Sample

Adhesive-1 with no additive was coated as described for Examples 17-18, Part I above.

Part II: Preparation and Testing of Laminates

A tape of the adhesive sample prepared in Part I above was prepared by laminating the adhesive sample to a sample of Microporous Film. The release liner was removed from the tape and the adhesive side of the tape was laminated to a glass slide to form a 3 layer laminate. The laminate was placed to age in an 80° C. oven. The sample laminate was tested after 3 days by the Surface Wetting Screening Test using the test method described above. The result is shown in Table 13.

TABLE 13

| | | Surface Wetting |
|---|---|---|
| Example | Aging Temperature | after 3 days |
| 17 | 80° C. | Wets |
| 18 | 80° C. | Wets |
| C17 | 80° C. | Beads Up* |
| C18 | 80° C. | Beads Up |

*wets within two hours

### Comparative Example C19

Part I: Preparation of Adhesive Sample

A mixture of Adhesive-1 and 4.1% by weight of Additive-3 was prepared by heating to 80° C. for 10 minutes and rolling for 2 hrs on laboratory roller and coated with a doctor knife onto a Release Liner, and allowed to dry at room temperature for 24 hours to give a dry adhesive thickness of approximately 0.10 millimeters. The final concentration of Additive-1 in the dried adhesive was approximately 10% by weight.

Part II: Preparation and Testing of Laminates

A tape of the adhesive sample prepared in Part I above was prepared by laminating the adhesive sample to a sample of Microporous Film. The release liner was removed from the tape and the adhesive side of the tape was laminated to a glass slide to form a 3 layer laminate. The laminate was placed to age in an 80° C. oven. The sample laminate was tested after 3 days by the Surface Wetting Screening Test using the test method described above. The result is shown in Table 14.

### Comparative Example C20

Part I: Preparation of Adhesive Sample

Adhesive-1 with no additive was coated as described for Comparative Example C19, Part I above.

Part II: Preparation and Testing of Laminates

A tape of the adhesive sample prepared in Part I above was prepared by laminating the adhesive sample to a sample of Microporous Film. The release liner was removed from the tape and the adhesive side of the tape was laminated to a glass slide to form a 3 layer laminate. The laminate was placed to age in an 80° C. oven. The sample laminate was tested after 3 days by the Surface Wetting Screening Test using the test method described above. The result is shown in Table 14.

TABLE 14

| | | Surface Wetting |
|---|---|---|
| Example | Aging Temperature | after 3 days |
| C19 | 80° C. | Beads Up |
| C20 | 80° C. | Beads Up |

1. A hydrophilic article comprising:
a thermoplastic polymer layer having a first surface and a second surface having an adhesive layer bonded to said second surface, said adhesive layer comprising a surfactant that migrates to said first surface of said polymeric layer.

2. The hydrophilic article of claim 1 wherein said polymeric layer comprises films, porous membranes, microporous membranes, and fibrous polymer layers.

3. The hydrophilic article of claim 1 wherein said surfactant is selected from nonionic, anionic, and amphoteric surfactants or mixtures thereof.

4. The hydrophilic article of claim 3 wherein said surfactant is a fluorochemical nonionic surfactant.

5. The hydrophilic article of claim 4 wherein said surfactant is of the formula
(R_{f}-Q)ₙ-Z wherein
R_{f} represents a partially- or fully-fluorinated aliphatic group,
Q is an organic divalent or multivalent linking group or a covalent bond,
Z is a hydrophilic poly(oxyalkylene) group and n is 1 to 6.

6. The hydrophilic article of claim 5 wherein Z comprises a poly(oxyalkylene) of the formula (OR′)ₓ wherein R′ is an alkylene group of 2 to 4 carbon atoms, and x is a number from 4 to 25.

7. The hydrophilic article of claim 5 wherein said poly(oxyalkylene) group is terminated by a hydroxyl, an alkyl, alkaryl ether, or fluoroalkyl ether.

8. The hydrophilic article of claim 3 wherein said nonionic surfactant is of the formula:
Rₕ¹—Y¹—W—Y²—Rₕ², wherein:
W represents a polyoxyalkylene group;
Y¹ and Y² independently represent an oxygen or sulfur atom or a group of the formula —CO—, —COO—, —NH—, —CONH—, or —N(R)—, where R is an alkyl group or an aryl group;
Rₕ¹ represents an alkyl or an aryl group, or a combination thereof, and
Rₕ² represents a hydrogen atom or is an alkyl or an aryl group, or a combination thereof.

9. The hydrophilic article of claim 8 wherein said nonionic surfactant wherein said poly(oxyalkylene) group contains from 4 to 25 oxyalkylene units.

10. The hydrophilic article of claim 1 wherein said surfactant is present in an amount sufficient to render said thermoplastic polymer layer hydrophilic.

11. The hydrophilic article of claim 10 wherein said adhesive layer comprises at least 3 wt. % of said surfactant.

12. The hydrophilic article of claim 10 wherein said adhesive layer comprises 5 to 40 wt. % of said surfactant.

13. The hydrophilic article of claim 1 wherein said polymeric layer is selected from polyesters, polyurethanes, polyamides and poly(alpha)olefins

14. The hydrophilic article of claim 1 wherein said polymeric layer is selected from homo-, co- and terpolymers of aliphatic mono-alpha olefins.

15. The hydrophilic article of claim 1 wherein said polymeric layer is selected from homo-, co- and terpolymers of ethylene and propylene.

16. The hydrophilic article of claim 1, wherein said adhesive layer is a pressure sensitive adhesive layer.

17. The hydrophilic article of claim 1 further comprising a release liner.

18. The hydrophilic article of claim 1, wherein said thermoplastic polymer layer is patterned.

19. The hydrophilic article of claim 1 printed on at least a portion of the hydrophilic surface with an image pattern of ink.

20. The hydrophilic article of claim 19 wherein said ink is an aqueous ink.

21. The hydrophilic article of claim 1 wherein said thermoplastic polymer layer is initially hydrophobic

22. A liquid transport article comprising the hydrophilic article of claim 1, wherein the thermoplastic polymer layer comprises a microstructure-bearing surface with a plurality of channels that facilitate the directional flow of a liquid disposed thereon.

23. A method of preparing a hydrophilic article according to claim 1 comprising coating a thermoplastic polymer layer with an adhesive layer, said adhesive layer comprising a surfactant that migrates to said first surface of said polymeric layer.

24. The method of claim 23 wherein said thermoplastic polymer layer comprises a film, a membrane, or a fibrous polymer layer.

25. The method of claim 23 wherein said surfactant is present in an amount sufficient to render said thermoplastic polymer layer hydrophilic.

26. The method of claim 23 wherein said surfactant is selected from nonionic, anionic, and amphoteric surfactants.

27. The method of claim 26 wherein said surfactant is a fluorochemical nonionic surfactant.

28. The method of claim 23 wherein said surfactant is present in an amount sufficient to render said thermoplastic polymer layer hydrophilic.

29. The method of claim 28 wherein said adhesive layer comprises at least 3 wt. % of said surfactant.
